(19) United States
(12) Patent Application Publication
(10) Pub. No.: US 2005/0104909 A1
(43) Pub. Date: May 19, 2005

(54) Communications system and method

(75) Inventors: Shinichiro Okamura, Yokohama (JP); Kazushige Hiroi, Machida (JP); Takeo Tomokane, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/958,686

(22) Filed: Oct. 4, 2004

(30) Foreign Application Priority Data
Oct. 15, 2003 (JP) 2003-355359

(51) Int. Cl. G09G 5/02

(52) U.S. Cl. 345/698

(57) ABSTRACT

A communication terminal includes a display device configured to display an image on the display device according to image display parameters; a processor to process the images data; and a communication interface to transmit or receive data, the communication interface configured to be coupled to a remote image processing device via a network. Unnecessary data is prevented from being transmitted, and it becomes possible to reduce processing loads on the terminals to thereby display only the focused image data section in a shared fashion between the terminals during the communication. When a communication is conducted in real time, it can be explicitly indicated on what section of image data a user of a terminal which is to transmit the image data and a user of a terminal which is to receive the image data are to focus each other's attention during the communication.

### CROSS-REFERENCE TO RELATED APPLICATIONS

The present application claims priority to Japanese Patent Application No. 2003-355359, filed on Oct. 15, 2003.

### BACKGROUND OF THE INVENTION

The present invention relates to a communication system, and more particularly, to a communication system used and suitable for transmitting/receiving static image data and/or dynamic image data.

In general, when voice data, hand-written data, and/or image data is to be exchanged between terminals during communication using a wireless network, to ensure effective use of a limited communication band of the network, the amount of data to be transmitted is reduced by applying a technology for compressing static image data/dynamic image data, such as JPEG or MPEG. Also, the technology described in, for example, JP10-51773, and in other documents, is known as a conventional technology relating to a method of transmitting/receiving dynamic image data smoothly between terminals by using the limited communication band of the network. This conventional technology is used to transmit image data and reduce a data size of the image data by suppressing radio-frequency components thereof when the network is congested in terms of traffic.

When a wireless network is used with a mobile telephone, a PDA (Personal Digital Assistant), or the like, in a city, it may be possible to secure t a sufficient communication bandwidth. There is also the problem that even when a technology for compressing static image data or dynamic image data is used to standards such as JPEG or MPEG, it may be difficult to transmit desired image data.

In addition, mobile telephone, PDAs, and other hand-held terminals have relatively low processing power compared to stationary terminals, e.g., personal computers (PCs). Accordingly, handheld devices are generally unable to experience problem processing a large volume of data transmitted by stationary terminals. Furthermore, when image are transmitted/received using mobile telephones or PDAs, output screen resolution (the number of vertical and/or horizontal dots that defines an output screen) may differ between the transmitting terminal and the receiving terminal. In such a case, even when users of the two terminals wish to simultaneously view the same section of image data as that being viewed at each other's terminal, the same section may not be displayed at the other terminal.

Besides, when a communication is to be conducted in real time between terminals via a wireless network, it is important that each device displays the same image. Assume, for example, that both users are talking about an entire image of a person's portrait while transmitting/receiving voice data using the respective terminals. In this example, it is preferable that although slightly unclear, the image transmitted/received should be of a state in which the entire image of the portrait can be viewed at both of the terminals. In another example, in which a specific section of an image is being discussed, the specific section of interest should be displayed on the both devices.

However,in the method according to the conventional technology described in JP Laid-open No. 10-51773, the radio-frequency components of the image are suppressed when the network becomes congested in terms of traffic. The method using the conventional technology, therefore, is problematic if a specific section of an image is not displayed due to the traffic bottleneck.

When, as described above, a communication is to be conducted in real time between the terminals connected via a wireless network, it may be difficult to communication smoothly unless the display method to be used is changed according to communication conditions or display parameters. The display parameters include a resolution (i.e., the number of vertical and/or horizontal dots that defines a display screen) of the display device of the terminal which is to receive image data during the communication and information on what section of an image the transmitting device is to transmit to the receiving device, so that the users of these devices can focus on the same section of the image.

### BRIEF SUMMARY OF THE INVENTION

The embodiments of the invention provide the following features:
when a communication is conducted in real time between terminals each having a display device different in the number of vertical and/or horizontal dots or pixel that defines an output screen, it can be explicitly indicated what section of image data a transmitting terminal is to transmit to the receiving terminal;
the terminal to transmit the image data can first consider the focused section of the image data and an output resolution (i.e., the number of vertical and/or horizontal dots that defines an output screen) of the terminal which is to receive the image data, then reduce the size of the image data or extract a part thereof, and transmit the image data; and
accordingly, since unnecessary data can be prevented from being transmitted, it becomes possible to reduce processing loads on the terminals and display only the focused image data section in a shared fashion between the terminals during the communication.

According to the present embodiment, the above object can be achieved as follow; in a communication system for transmitting/receiving data between terminal, wherein:
first, prior to communication, each terminal transmits/receives information on the number of vertical and horizontal dots that defines one another's output display screen;
thus, a terminal that is to commence transmission acquires information on the number of vertical and horizontal dots that defines the output display screen of another terminal which is to cooperate together in the communication; and
the above terminals communication with each other by arbitrarily selecting a combination of transmitting/receiving image data, transmitting/receiving image data and hand-written data, transmitting/receiving image data and voice data, and transmitting/receiving image data, hand-written data, and voice data.

According to the present embodiments, when two or more terminals each having a different number of vertical and/or horizontal dots that defines an output screen of one another's display device transmit/receive static image data or dynamic image data to/from one another, it is possible to reduce the transmission of unnecessary data and realize smooth communication.

In one embodiment, a communication terminal includes a display device configured to display an image on the display device according to image parameter; a processor to process the image data; and a communication interface to transmit or receive data, the communication interface configured to be couple to be coupled to a remote image processing device via a network. The communication terminal transmits the display parameters to the remote image processing terminal and the remote image processing device. The communication terminal receives first image data of a first image from the remote image processing device after the display parameters has been transmitted to the remote image processing device, the first image being a modified version of a first original image. The first image is modified according to the display parameters provided to the remote image processing device by the communication terminal.

In another embodiment, a communication terminal includes a display device configured to display an image on the display device according to image first display parameters; a processor to process the image data; and a communication interface to transmit or receive data, the communication interface configured to be coupled to a remote handheld communication terminal via a network. The communication terminal receives second display parameters from the handheld communication terminal, the second display information providing information on resolution and size of an image that the handheld communication terminal is configured to display on a display area of the handheld communication terminal. The communication terminal generates a first image from an original image according to the second display parameters received from the handheld communication terminal, the first image being represented by first image data. The first image data are transmitted to the handheld communication terminal.

In yet another embodiment, a method for operating a communication terminal having a display device and a processor includes transmitting display parameters of the display device to the remote image processing device to commence an image data communication operation between the communication terminal and remote image processing device; and receiving at the communication terminal first image data of a first image from the remote image processing device after the display parameters has been transmitted to the remote image processing device, the first image being a modified version of a first original image. The first is modified according to the display parameters provided to the remote image processing device by the communication terminal.

### BRIEF DESCRIPTION OF THE DRAWINGS

FIG. 1 is a diagram explaining the outline of image reduction/extraction in an embodiment of the present invention;

FIG. 2 is a block diagram showing the total configuration of the communication system in the above-described embodiment of the present invention;

FIG. 3 is a block diagram showing the hardward configuration of a terminal;

FIG 4. is a block diagram showing the software configuration of a terminal;

FIG. 5 is a diagram explaining an example of a display screen configuration of a terminal;

FIG 6 is a diagram explaining another example of a display screen configuration of a terminal;

FIG. 7 is a diagram showing an example of a table in which screen sizes of display devices are stored for each terminal managed by the device information management block;

FIG. 8 is a diagram explaining the configuration of a control chart relating to the image data managed by a terminal;

FIG. 9 is a flowchart explaining the processing operation of terminals when the terminals communicate with one another;

FIG. 10 is another flowchart explaining the processing operation of terminals when the terminals communicate with one another;

FIG. 11 is a flowchart explaining the processing operation of the device information management block in step 803 of FIG. 9;

FIG. 12 is a flowchart explaining the processing operation of the image-processing management block in step 815 of FIG. 9;

FIG. 13 is a flowchart explaining the processing operation of the image acquisition block in step 817 of FIG. 9;

FIG. 14 is a flowchart explaining the processing operation of the image-processing block in step 819 of FIG. 9;

FIG. 15 is a flowchart explaining the processing operation of the reduced-image creating block in step 1203 of FIG. 14;

FIG. 16 is a flowchart explaining the processing operation of the image data-receiving block in steps 821,825 of FIG. 9;

FIG. 17 is a flowchart explaining the processing operation of the image data-transmitting block in steps 829,831 of FIG. 9;

FIG. 18 is a flowchart explaining the processing operation of the voice-transmitting block in step 835 of FIG. 10;

FIG. 19 is a flowchart explaining the processing operation of the voice-receiving block in step 835 of FIG. 10;

FIG. 20 is a flowchart explaining the processing operation of the hand-written data transmitting block in step 835 of FIG. 10;

FIG. 21 is a flowchart explaining the processing operation of the hand-written data receiving block in step 839 of FIG. 10; and

FIG. 22 is a flowchart explaining the processing operation of the display control block in step 842 of FIG. 10.

### DETAILED DESCRIPTION OF THE INVENTION

An embodiment of a communication system according to the present invention will be described in detail below with reference to the accompanying drawings.

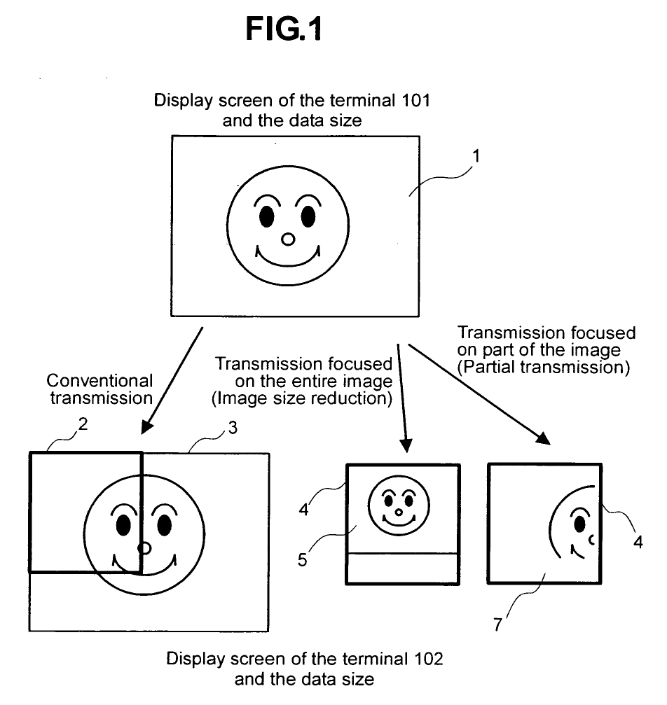

FIG. 1 is a diagram explaining the outline of image reduction/extraction according to an embodiment of the present invention.

In FIG. 1, image data 1 shown in an upper row is an example of the image data displayed on a display of a terminal 101 which to operate as a transmitting terminal. It is to be assumed that the size of a frame of the image data 1 indicates that size or resolution of the display device of the transmitting terminal 101 (i.e., the number of vertical and/or horizontal display dot/pixels). Is is to be assumed that a user of the terminal 101 transmits all or part of the image data 1 to a terminal 102 (receiving terminal) equipped with a display device having a display region 2 of the size (i.e., the number of vertical and/or horizontal display dots) shown as a thick line in a lower row, at the left end of the figure.

In one implementation, the transmitting terminal 101 is a personal computer and the receiving terminal 102 is a portable or handheld device. The handheld device is a device that is configured to be operated while being held on a user's hand, e.g., a mobile phone or personal digital assistant. These terminals have be other types of devices in other implementations.

In the above example, if the image data 1 is transmitted from the terminal 101 to the terminal 102 in accordance with the conventional technology, the image received at the terminal 102 will be of a size 3 larger than the size of the display region 2. As shown at the lower left end of FIG. 1, therefore, only a part of the transmitted image will be displayed in the display region 2 of the receiving terminal 102.

In the present invention, when a communication is conducted, it is explicitly indicated on the display of the transmitting terminal what section of the image data is to be transmitted during the communication. Also, the transmitting terminal considers the focused section of the image data and the size of the display device of the receiving of the terminal (i.e., the size of the image data or extracts a part thereof, and transmits the thus-processed image data. Accordingly, transmission of unnecessary data can bee prevented, which, in turn, make it possible to reduce processing loads on the terminals and thus to display only the focused image data section in a shared fashion between the terminals during the communication.

That is, in the example of FIG. 1, the transmitting terminal 101 sets the size of the display device of the terminal 102 (i.e., the number of vertical and horizontal display dots) and the image section on which attention is focused during the communication. Next after processing the image data, the terminal 101 transmits the data. For example, if attention is focused on the entire image, the terminal 101 transmits to the terminal 102 image data 5 of the image that was reduced in size so as to fit within a display region 4 of the terminal 102. If attention is focused on a part of the image, the terminal 101 transmits image data 7 that was extracted so as to fit within the display region 4.

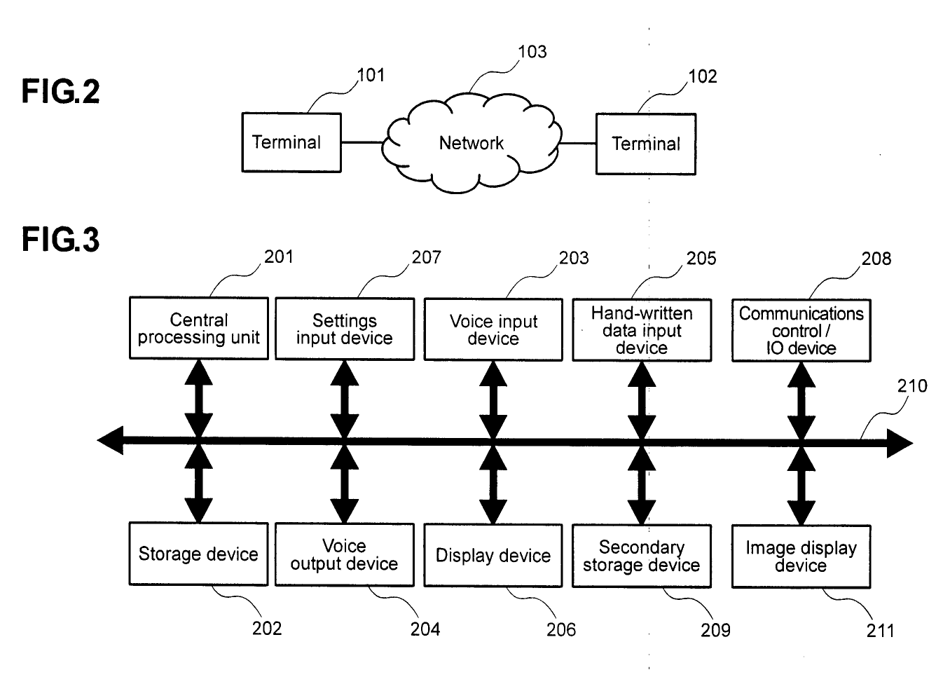

FIG. 2 is a block diagram showing an overall configuration of the communication system in the above-described embodiment of the present invention. FIG. 2 shows the concept large number of terminal to communication can be connected to the network 103.

In FIG. 2, the terminals 101 and 102 can both be configured using a PC, a PDA, a mobile telephone, a set-top box, or the like, and both terminals can be any device that allow installation of the hardware configuration and software configuration described later. The terminals 101 and 102 both have a plurality of image data storage regions. Both are also configured with a hand-writing plane for storing hand-written data, and an image plane for storing display image data, camera-acquired image data, reduced-size image data that is processed image data. For example, if the terminals 101 and 102 differ in the number of vertical and/or horizontal dots that defines respective output screens, even when the terminal 101 transmits the image data that it can display, only part of the image data may be displayed at the terminal 102if the number of vertical and horizontal dots displayed on the screen of the display device of the terminal 102 less than that of the terminal 101.

In the above-described embodiment of the present invention, in order to solve such a problem, the terminals first notify to each other the size of the display on the screen). Next, the device (i.e., the number of vertical and horizontal dots displayed on the screen). Next, the terminal to transmit image data conducts image data processing based on size information of the display region of the terminal to receive the image data, and then starts the transmission. Image data processing can be accomplished by reducing the size of the entire image at the transmitting terminal, by extracting a part of the image at the image at the transmitting terminal, or by using other methods. Hence, it become possible, during inter-terminal communication, to output a desired image section between terminals each having a different number of vertical and/or horizontal dots that defines an output screen of a display device. Smooth communication can thus be realized.

FIG. 3 is a block diagram showing the hardware configuration of a terminal. In FIG. 3, numeral 201 denotes a central processing unit, numeral 202 a storage device, numeral 203 a voice input device, numeral 204 a voice output device, and numeral 205 a hand-written data input device. Numeral 206 denotes a display device, numeral 207 a setting input device, numeral 208 a communication control/IO (input/output device, numeral 209 a secondary storage device, numeral 210 a bus, and numeral 211 an image display device.

As shown in FIG. 3, each of the terminals 101, 102 includes the various functional components 201-209 and 211, each of the components being connected to the bus 210. Each of these functional components is described below.

The central processing unit 201 reads data from the storage device 202, processes the thus-read data, writes processed data into the storage device 202, and conducts other processes The storage device 202 retains the data read/written by the central processing unit 201. The voice input device 203 stores input voice data into the storage device 202, and the voice output device 204 outputs the voice data received from the storage device 202. The hand-written data input device 205 stores into the storage device 202 the data input by use of a pen. The display device 206 displays the data received from the central processing unit 201. The settings the data to the storage device 202. The communications control/IO device 208 receives data via a network and outputs onto the network the data the central processing unit 201 retains in the storage device 202. The bus 210 is used for the internal components of the terminal to transmit/receive data between one another. The image input device 211 output to the storage device 202 the images acquired using a means such as a camera not shown.

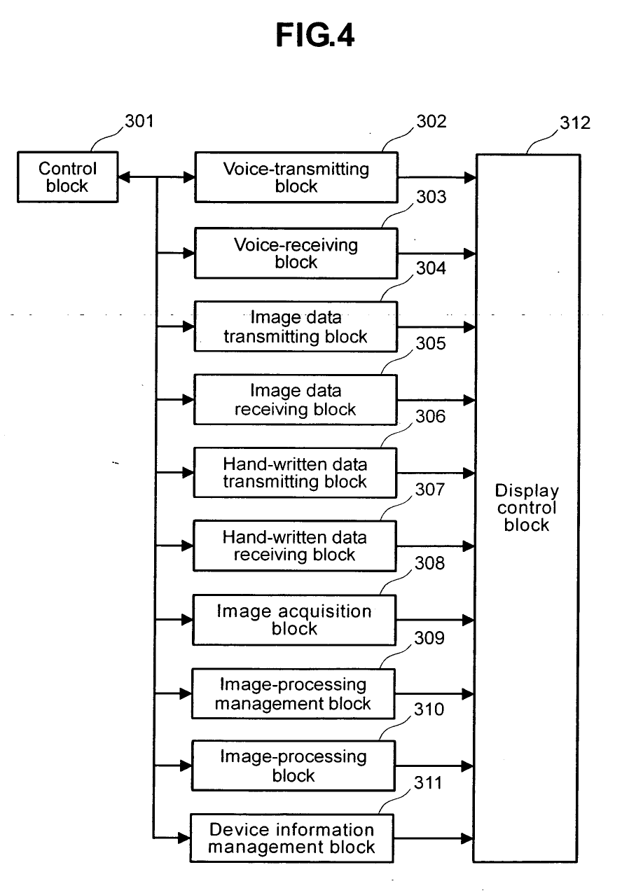

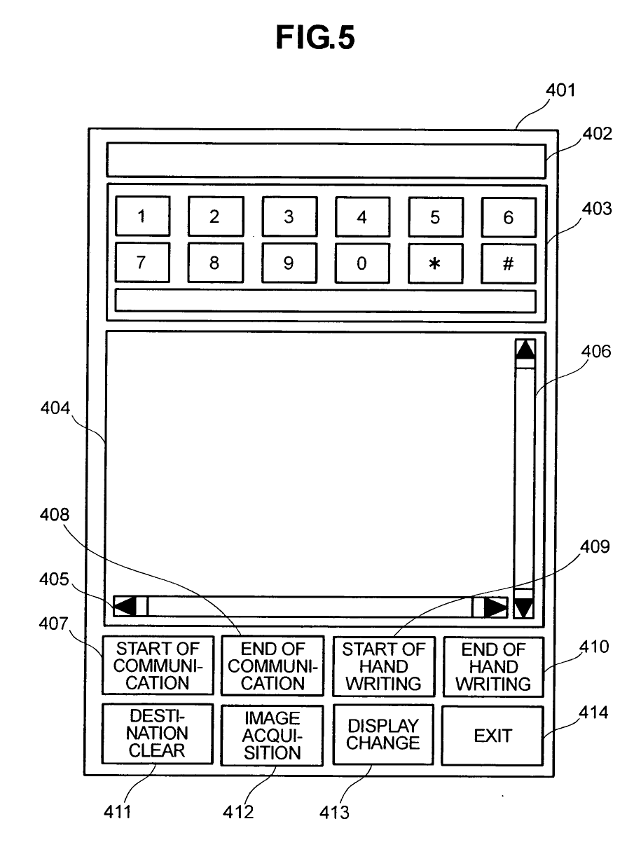

FIG. 4 is a block diagram showing the software configuration of a terminal. In FIG. 4, numeral 301 denotes a control block, numeral 302 a voice-transmitting block, numeral 303 a vice-receiving block, numeral 304 an image data transmitting block, and numeral 305 an image data receiving block. Numeral 306 denotes a hand-written data transmitting block, and numeral 307 a hand-written data receiving block. Numeral 308 denotes an image acquisition block, numeral 309 an image-processing management block, numeral 310 an image-processing block, numeral 311 a device information management block, and numeral 312 a display control block.

As shown in FIG. 4, each of the terminals 101, 102 includes the various software components 302 to 311, and each of the components is connected to the control block 301 and the display control block 312, both of the blocks also being software components, Each of these software components is described below.

The control block 301 controls the operation of the software component 302 to 311. The voice-transmitting block 302 transmits voice data, and the voice-receiving block 303 receives the voice data. The image data-receiving block 305 receives and processes the static image data or the dynamic image data. The hand-written data transmitting block 306 transmits hand-written data, and the hand-written data receiving block 307 receives and processes the hand-written data. The image acquisition block 308 acquires image data from a camera or the like. The image-processing management block 309 manages whether, on the basis of the information defining the size of the display device of the receiving terminal (i,e., the number of vertical and horizontal dots of the output screen), the transmitting terminal is to process static image data or dynamic image data before transmitting the image data. On the basis of the information defining the size of the display device of the receiving terminal (i.e., the number of vertical and horizontal dots of the output screen), the image-processing block 310 changes a data size of the static image data or dynamic image data that the transmitting terminal is to transmit. The device information management block 311 manages the number of vertical and horizontal dots for each output screen of the display device belonging to the terminal including the device information management block 311, and to the other terminal. In other words, the device information management block 311 manages the information requires for the transmitting or receiving terminal to notify to each other the information that defines the size of the display device (i.e., the number of vertical and horizontal dots of the output screen). The display control block 312 creats superimposed screen data from different types of data such as static image data or dynamic image data and hand-written data, and controls display on the display unit.

FIG. 5 is a diagram explaining an example of a display screen configuration of a terminal. The example in FIG. 5 shows a configuration in which input buttons, buttons for performing various functions, another elements are adapted to be displayed on the display screen. The display device using this example is therefore constructed with a touch panel or may have a pointing device not shown.

As shown in FIG. 5, the display screen includes a variety of elements displayed in a display frame 401 that defines a defines a size of the entire of the entire display region of the display screen. That is, these elements include: a region 402 for displaying text and a name of an application program; a display region 403 for the software-based buttons provided for user input; an image data display region 404 for displaying image data, hand-written data, and text data; scroll bars 405 and 406 both for changing a display position when image data is of a size larger than that of the image data display region 404; a START OF COMMUNICATION button 407 for starting communication between terminals; an END OF COMMUNICATION button 408 for stopping the communication between the terminals; a START OF HAND WRITING button 409 for starting input of hand-written data; an END OF HAND WRITING button 410 for starting the input of hand-written data; a DESTINATION CLEAR button 411 for clearing a name and address of a communication destination terminal when communication is started; an IMAGE ACQUISITION button 412 for acquiring images using a camera accompanying the terminal; a DISPLAY CHANGE button 413 for determining whether a size of image data is to be reduced to the size of the entire display region of the terminal (i.e., the number of vertical and horizontal dots of the output screen); and a EXIT button 414 for exiting the application program.

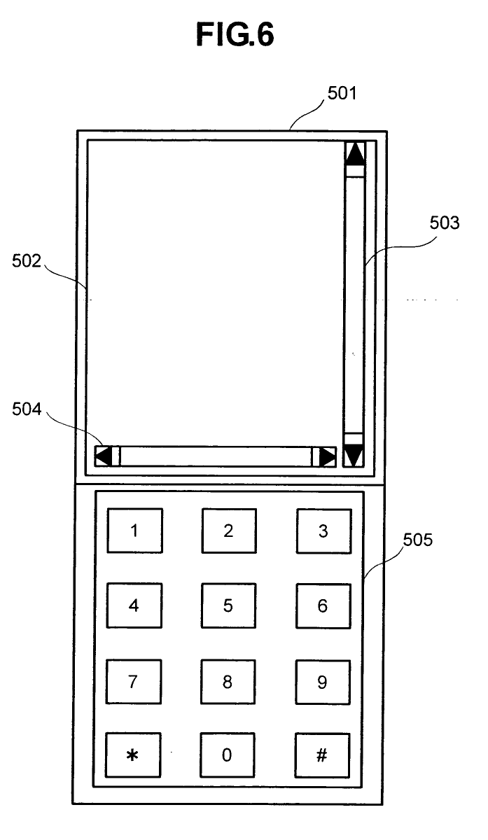

FIG. 6 is a diagram explaining another example of a display screen configuration of a terminal. The example in FIG. 6 shows a configuration in which input buttons, buttons for performing various functions, and other elements are provided outside the entire display region of the display screen.

As shown in FIG. 6, the display screen is constructed so as to have, within a display frame 501 that defines a size of the entire display region of the display screen, an image data display region 502 for displaying image data, hand-written data, and text data. The display screen further has, within the image data display region 502, scroll bars 503 and 504 both for changing a display position when image data is of a size larger than that of the image data display region 502. In addition, numeric keys 503 for selection of an image to be transmitted and for input of text data and the like, are arranged outside the display frame 501. Although only the numeric keys 505 are shown in FIG. 6, various such buttons as described per FIG. 5 may be provided in that place. Furthermore, text data can be input from the input from the image data display region 502 by using a stylus.

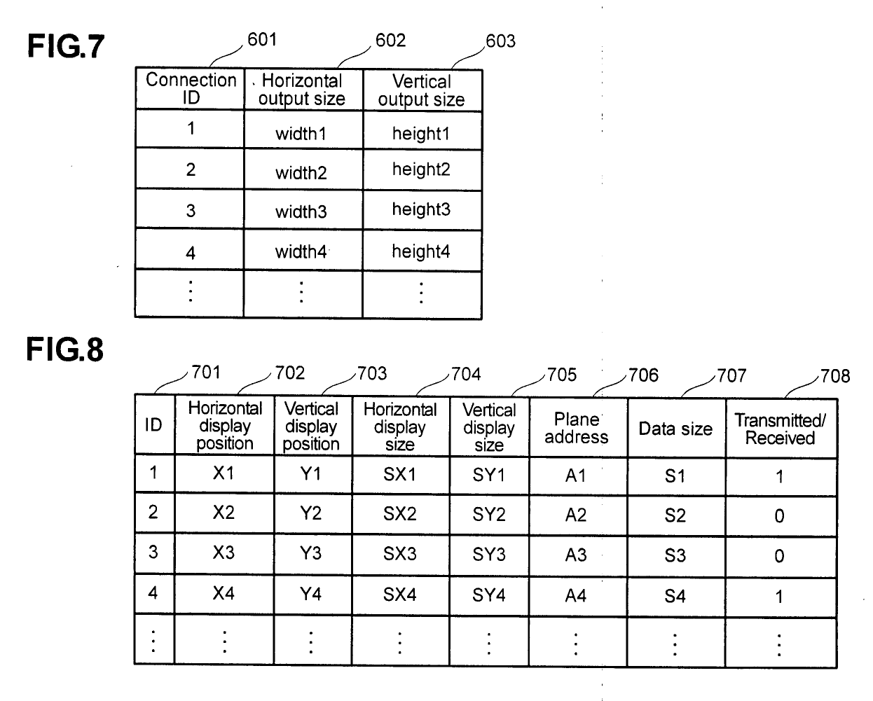

FIG. 7 is a diagram showing an example of a table in which screen sizes of display devices are stored for each terminal by the device information management block 311.

The table shown in FIG. 7 includes records each including, as one set, “Connection ID” 601, “Horizontal output size” 602, and “Vertical output size ” 603. The “Connection ID” 601 is an ID number that uniquely identifies a terminal. The “Connection ID” can also be a session ID. Thus, the terminal can retain an manage the horizontal and vertical sizes of the display screens (i.e., the number of vertical and horizontal dots that defines each display screen) of all currently connected terminals including that terminal.

FIG. 8 is a diagram explaining the configuration of a control chart relating to the image data managed by a terminal. In accordance with such control chart as shown in FIG. 8, each of the terminals 101 and 102 manages the static image data or dynamic image data input/received from the image input device 211 shown in FIG. 3.

In FIG. 8, “ID” is an ID for an image, “Horizontal display position” 702 indicates a starting horizontal coordinate at which the image is displayed, and “Vertical display position” 703 indicates a starting vertical coordinate at which the image is displayed. “Horizontal display size” 704 indicates a horizontal size of the image, and “Vertical display size” 705 indicates a vertical size of the image. “Plane address” 706 indicates where the image is retained, “Data size ” 707 indicates a data size of the image, and “Transmitted/Received” 708 indicates whether image data has been transmitted to a connected terminal.

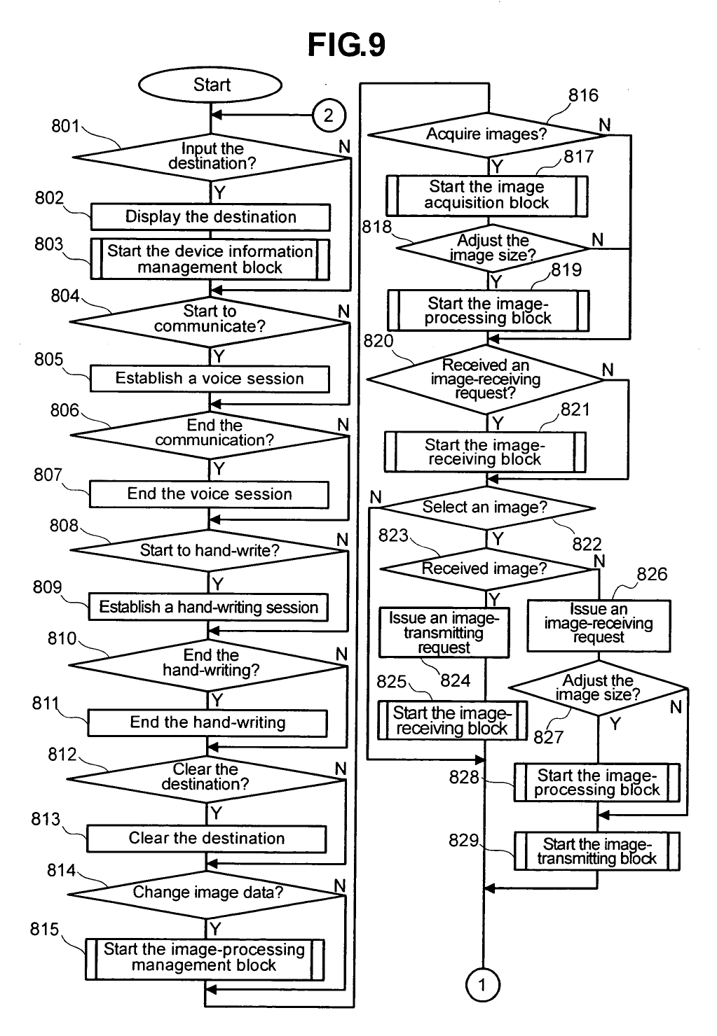

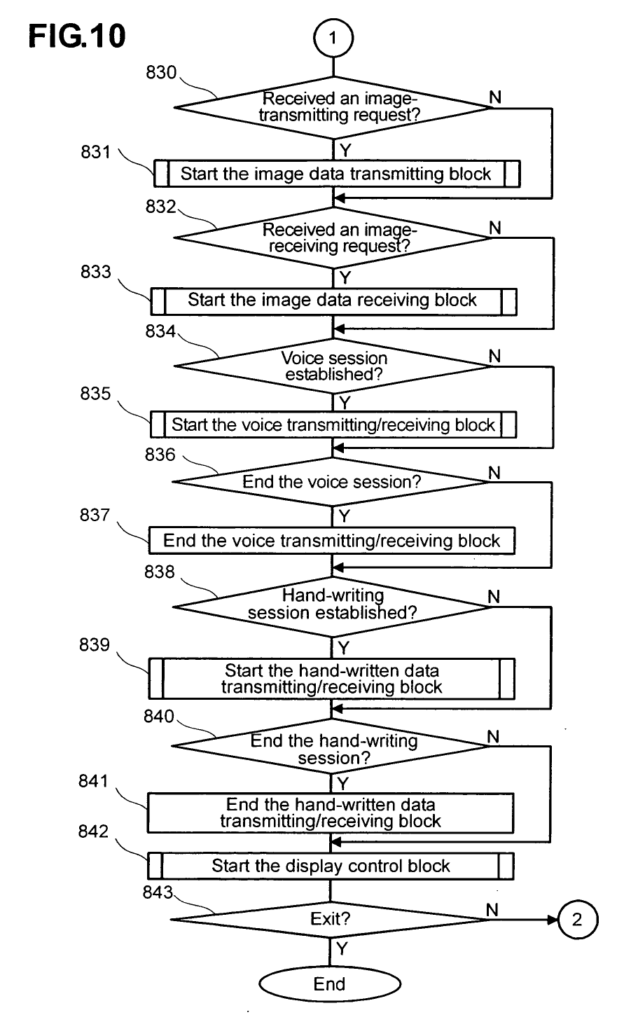

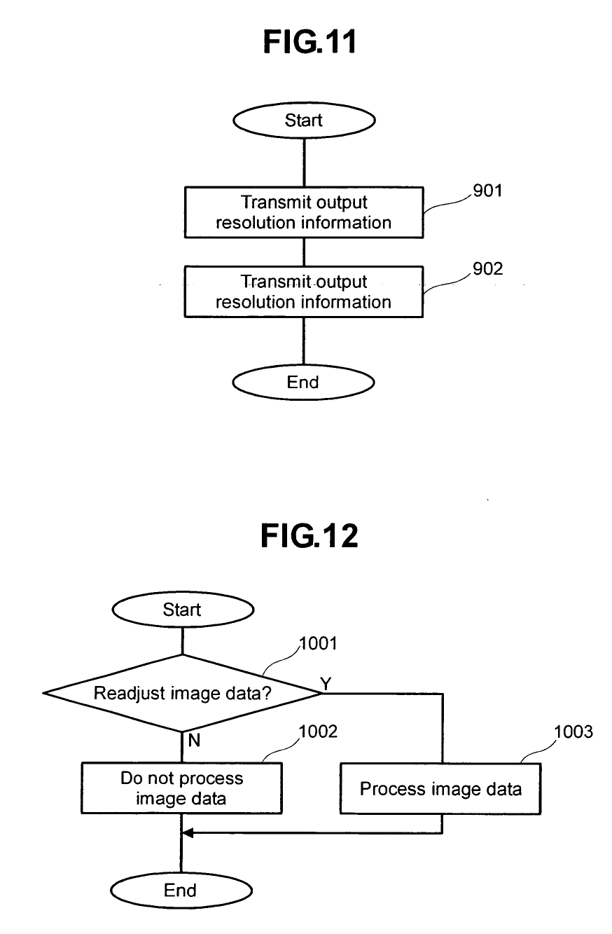

FIGS. 9 and 10 are flowcharts explaining the processing operation of terminals when the terminals communicate transmitting/receiving static image data or dynamic image data to/from one another. FIGS. 11 to 22 are flowcharts explaining details of the processing operation of major steps in the flowchart of FIG. 10. Next, the flow of these steps is described below as a series of steps.

(1) Before starting connection, a user of a terminal which is to start communication inputs a destination, namely, an address, of another terminal with which to communicate. The destination is an IP address, a telephone number, a name, or any other data that allows the other terminal to be uniquely identified. When the destination is input, the input data relating to the other terminal is displayed on the screen and a connection request is transmitted. (Steps 801 and 802)

(2) When the communication is started and a voice session is established, the device information management block 311 is started. In accordance with the flowchart of FIG. 11, the device information management block 311. The screen size information here refers to that managed as the size information of display devices that is described using FIG. 7. By the transmission, the device information management block 311 acquires information on the screen size of the first terminal with which the communication was started. (Steps 803, 901, 902)

(3) Meanwhile, if the connection request is received either after processing in step 902 or without destination being input in step 804, that terminal determines whether talking is to be started. If talking is to be started, a voice session for transmitting/receiving voice data is established. Whether the voice session is to be arbitrarily established between the terminals can be determined, (Steps 804, 805)

(4) Talking can be ended after the establishment of the voice session or without talking being started, and if talking is to be ended, the voice session is terminated. In this case, the voice session can be terminated from either of the two terminals. (Steps 806, 807)

(5) The terminal that started the communication can determine whether a hand-writing session for transmitting/receiving hand-written data is to be stored. If hand-written data is to be transmitted/received, the hand-writing session is established. Whether the hand-writing session is to be arbitrarily established between the terminals can be determined. (Steps 808, 809)

(6) Hand-writing can be ended after the establishment of the hand-writing session or without hand-writing being started, and if hand-writing is to be ended, the hand-writing session is terminated. In this case, the hand-writing session can be terminated from either of the two terminals. (Steps 810, 811)

(7) When it also wishes to start communicating with another terminal, the terminal can start communicating with the second terminal, by clearing the destination and assigning a new destination. (Steps 812, 813)

(8) Next, it is judged whether a particular setting of an adjustment screen transmission flag for judging whether to reduce a size of the image or to extract part thereof and transmit the image data in a reduce-size format is to be changed. If the setting is to be changed, the image-processing management block 309 is started. The image-processing management block 309 can be started from either of the two terminals. (Steps 814, 815)

(9) The image-processing management block 309 transmits the image data in a processed format to a reduced-size screen (smaller screen) or the like in accordance with the flowchart of FIG. 12. For this reason, whether an adjustment screen is to be displayed is judged, and if the adjustment screen is to be displayed, processing screen transmission is turned ON. If the image data is to be transmitted in a non-processed format, processing screen transmission is turned OFF. (Steps 1001 to 1003) That is, it is first determined whether or not the image data is to adjusted prior to being transmitted to the receiving terminal (step 1001). If so, the image data is adjusted or processing screen transmission is set to be ON (step 1003). If not, the image data is not adjusted or processing screen transmission is set to be OFF (step 1002).

(10) Next, it is judged whether any input image data from a camera or the like is to be transmitted to the current communication destination terminal. If image data is to be transmitted, the image acquisition block 308 is activated to start acquiring image data. (Steps 816, 817)

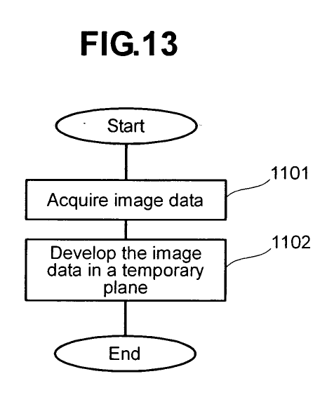

(11) In accordance with the flowchart of FIG. 13, the image acquisition block 308 acquires the image data input from the camera or the like and retains the image data in a temporary plane or a temporary data storage region. (Steps 1101, 1102). That is, the image data are acquired (step 1101) and provide the image in a temporary plane (step 1102).

(12) Next, it is determined whether an image size of any image retained in the temporary plane is to be changed. Whether the image size is to be changed is determined according to a state of the adjustment image transmission flag managed by the image-processing management block 309. If the adjustment image transmission flag is On, the image-processing block 310 is started. (Steps 818, 819)

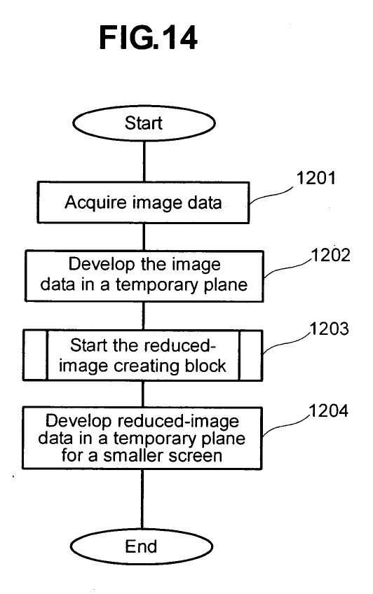

(13) In accordance with flowchart of FIG. 14, the image-processing block 310 acquires image data if an image to be adjusted is not present in the temporary plane, and develops the image data in the temporary plane. After the image data has been developed in the temporary plane, a reduced-image creating block (not shown) is started that is provided in the image-processing block 310 for adjusting the image data. (Steps 1201 to 1203) That is, the image data is acquired (step 1201); develop the image data in a temporary plane (step 1202); start the reduced-time block (step 1203); and develop reduced-image data in a temporary plane for a smaller screen (step 1204).

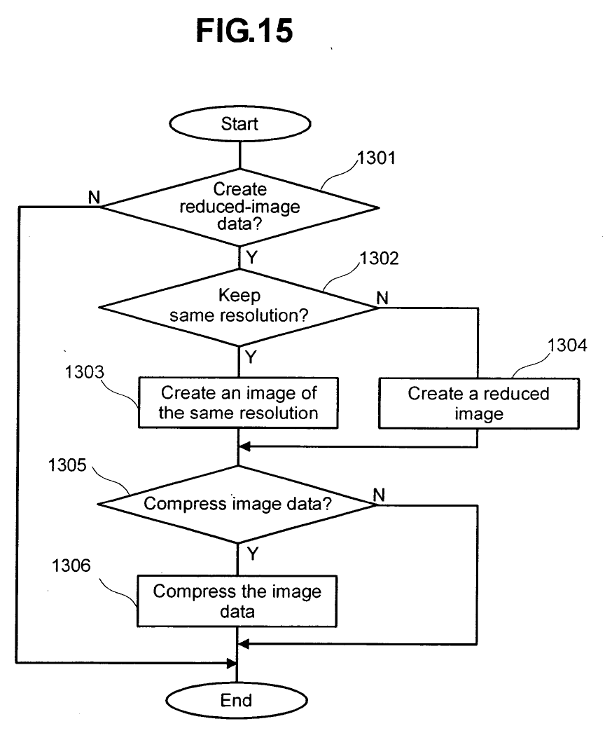

(14) In accordance with the flowchart of FIG. 15, the reduced-image creating block acquires display device information on the current communication destination terminal. Next, the reduced-image creating block judges whether image reduction is necessary (e.g., image data to be transmitted are to be reduced in amount), and if the reduction is not necessary, processing is terminated. (Step 1301)

(15) If, in step 1301, the image reduction is judged necessary, it is then judged whether the image is to be processed into an image of the same resolution by extracting only a range that can be displayed, not by changing the image size. (Step 1302)

(16) If, in step 1302, it is judged that a reduced image is to be created as an image of the same resolution, the image of the same resolution is created by extracting only a range that can be displayed at the current communication destination terminal, not by changing the image size. (Step 1303) That is, a relevant portion of the entire image is selected for transmission.

(17) If, in step 1302, it is judged that a reduced image is not to be created as an image of the same resolution, an image is created with horizontal and vertical sizes reduced to fit the display device size defined in the display device information of the current communication destination terminal. Thus, the entire image can be displayed. (Step 1304)

In one implementation, the transmitting terminal automatically selects whether to perform step 1304 or 1305. Also, the user of the terminal may conduct the determination or during the start of the communication.

(18) The reduction of the image size in the above-mentioned process is followed by selection of whether the reduced image is to be compressed, and if the image is not to be compressed, processing is terminated. If the image data is to be compressed, it is compressed using an appropriate compression method. Irrespective of whether image compression has been conducted, the image data that was created during the process in step 1303 or 1304 is subsequently developed in the temporary plane. (Steps 1305, 1306, 1204)

(19) Next, it is judged whether an image-receiving request has been received from the current communication destination terminal, and if the image-receiving request has been received, the image data-receiving block 305 is started. (Steps 820, 821)

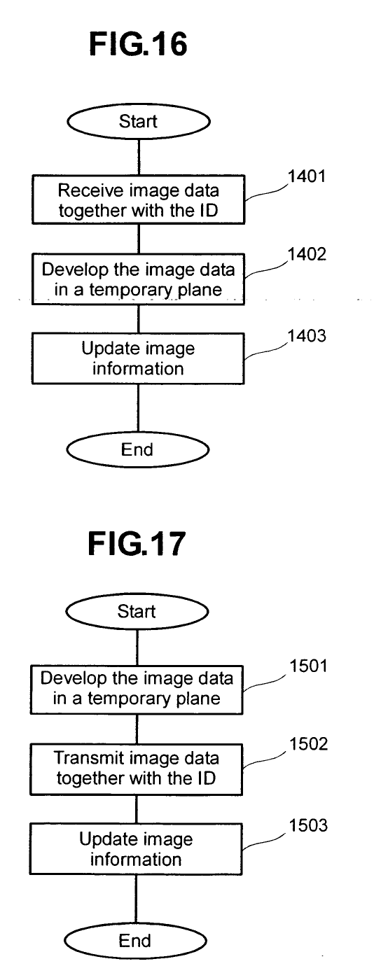

(20) In accordance with the flowchart of FIG. 16, the image data-receiving block 305 first receives image data and the ID data appended to the image data received (step 1401). If the received image data is compressed image data, the image data is decoded and then developed in the temporary plane (step 1402). Next, the ID of the received image data and other image information are registered in an image data control chart (step 1403).

(21) Whether to select an image to be displayed is judged, and if the image to be displayed is selected, whether the image selected from the images that the current communication destination terminal retains is to be displayed is then judged. If the image selected from the images that the current communication destination terminal retains is to be displayed, an image-terminal request is transmitted to the current communication destination terminal. (Steps 822 to 824)

(22) After this, the image data-receiving block 305 is started and it waits for image data to be sent from the destination terminal. The processing operation of the image data-receiving block 305 is the same as that described using the flowchart shown in FIG. 16. (Step 825)

(23) If, in step 823, it is judged that the image data retained in the destination terminal is to be transmitted, an image-receiving request is transmitted to the current communication destination terminal. Next, whether image size adjustments are to be performed is judged from the display device information of the current communication destination terminal, and if image size adjustments are to be performed, the image-processing block 310 is started. The processing operation of the image-processing block 310 is the same as that described using the flowchart shown in FIG. 14. (Steps 826 to 828)

(24) If, in step 827, it was judged that there is no need to perform image size adjustment, or after image size adjustments were performed in step 828, the image data-transmitting block 304 is started. (Step 829)

(25) In accordance with the flowchart of FIG. 17, the image data-transmitting block 304 develops in the temporary plane the image data that was adjusted in image size or that is to be transmitted intact, and then transmits the image data with ID data appended. After the transmission, information on the transmitted data is registered in the image data control chart. (Step 1501 to 1503)

(26) Next, whether an image-transmitting request has been received is judged and if the image transmitting request has been received, image data-transmitting block 304 is started and transmits image data. The processing operation of the image data-transmitting block 304 is the same as that described using the flowchart shown in FIG. 17. (Steps 830, 831)

(27) After this, whether an image-receiving request has been received is judged and if the image-receiving request has been received, image data-receiving block 305 is started and receives the image data. The processing operation of the image data-receiving block 305 is the same as that described using the flowchart shown in FIG. 16. (Steps 832, 833)

(28) Next, whether a voice session has been established is judged, and if the voice session has been established, the voice-transmitting block 302 and the voice-receiving block 303 are started. (Steps 834, 835)

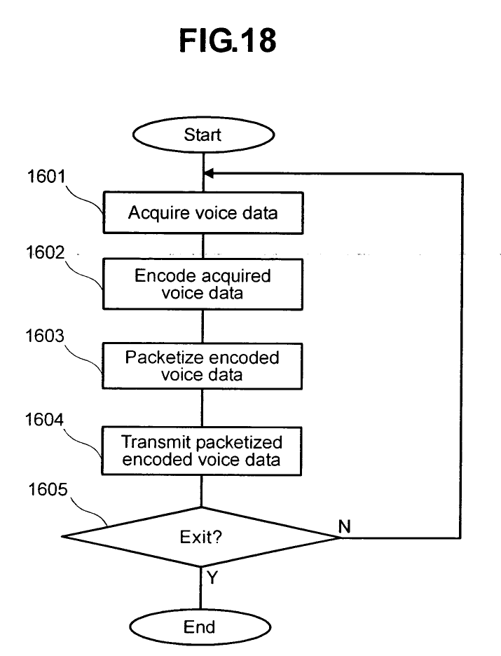

(29) In accordance with the flowchart of FIG. 18, the voice-transmitting block 302 acquires voice data, compressing the acquired voice data in a suitable encoding scheme, and transmitting the encoded voice data in a packet format. (Steps 1601 to 1604)

(30) Whether the next voice data to be acquired is present is judged and if the voice data is not present, the transmitting process is ended. If the next voice data is present, control is returned to step 1601, in which voice data is then acquired once again and packetized. The process of transmitting voice data is continued in this manner. (Step 1605)

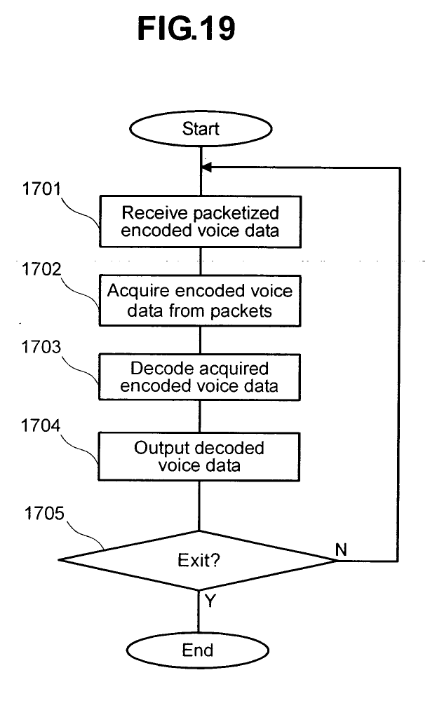

(31) In accordance with the flowchart of FIG. 19, the voice-receiving block 303 receives packetized encoded voice data and acquires the encoded voice data from the packets. After this, the voice-receiving block 303 decodes the acquired encoded voice data and outputs the voice data. (Step 1701 to 1704)

(32) Whether the next voice data to be received is present is judged and if the voice data is not present, the receiving process is ended. If the next voice data to be received is present, control is returned to step 1701, in which packetized encoded voice data is then received once again. The voice data output is continued in this manner. (Step 1705)

(33) Whether the voice session is to be terminated is judged and if the session is to be terminated, processing in both the voice-transmitting block 302 and the voice-receiving bock 303 is brought to an end. (Steps 836, 837)

(34) Next, whether a hand-writing session is established is judged and if the hand-writing session is established, the hand-written data transmitting block 306 and the hand-written data receiving block 307 are started. (Steps 838, 839)

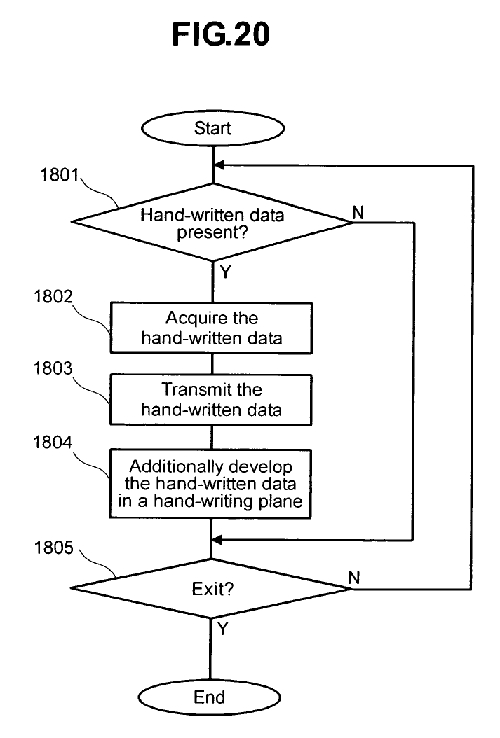

(35) In accordance with the flowchart of FIG. 20, the hand-written data transmitting block 306 judges whether the hand-written data is present, and if hand-written data is present, acquires the hand-written data and transmits the data to the current communication destination terminal. Next, the hand-written data transmitting block 306 adds the hand-written data to a hand-writing plane and updates the output hand-written data. (Steps 1801 to 1804)

(36) If, after processing in step 1804 or during the judgment in step 1801, hand-written data has not been present, whether the next hand-written data to be acquired is further judged. If the next hand-written data is not present, this transmitting process is ended. If the next hand-written data is present, control is returned to step 1801, in which hand-written data is then acquired once again. The process of transmitting hand-written data is continued in this manner. (Step 1805)

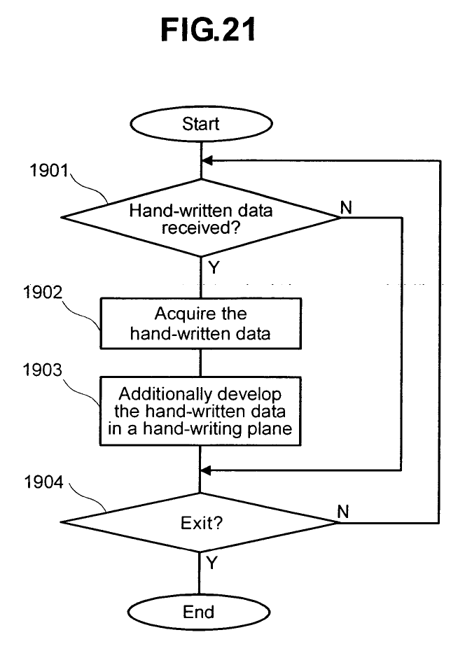

(37) In accordance with the flowchart of FIG. 21, the hand-written data receiving block 307 judges whether hand-written data has been received, and if hand-written data has been received, acquires the hand-written data. Furthermore the hand-written data receiving block 307 adds the hand-written data to the hand-writing plane, starting the display control block 312, and updating the output hand-written data. (Steps 1901 to 1903)

(38) If, after processing in step 1903 or during the judgment in step 1901, hand-written data has not been present, whether the next hand-written data to received is further judged. If the next hand-written data to be received is not present, this process is ended. If the next hand-written data to be received is present, control is returned to step 1901, from which the process of receiving hand-written data is continued once again. (Step 1904)

(39) Whether the hand-writing session is to be terminated is judged and if the session is to be terminated, processing both the hand-written data transmitting block 306 and the hand-written data receiving block 307 is brought to an end. (steps 840, 841)

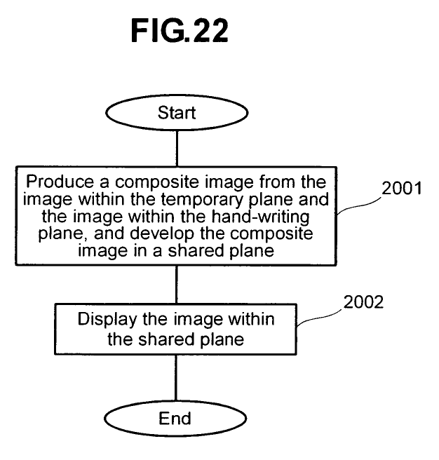

(40) Next, the display control block 312 is started. In accordance with the flowchart of FIG. 22, the display control block 312 creates a composite image by superimposing the image retained in the temporary plane the image in the hand-writing plane which retains hand-written data. After this, the display control block 312 develops the composite image in a shared plane and sends the created image within the shared plane to the screen of the terminal. (Steps 842, 2001, 2002)

During processing in the above-described embodiment of the present invention, when image data is reduced in size in accordance with size information on the output display screen of the receiving terminal (i.e., the number of vertical and horizontal display dots of the output screen) and then transmitted, the transmitting terminal can also update hand-written data coordinates according to a particular image data reduction ratio and transmit the updated hand-written data. The same section of an image can thus be indicated between terminals each different in the number of vertical and horizontal dots that defines the output screen of the display screen.

By executing above-described processing with a terminal, it becomes possible, during real-time and hand-written data) and static image data or dynamic image data to/from two or more terminals each different in the number of vertical and/or horizontal dots that defines an output screen of a display device of the terminal, to transmit/receive information on a size of a display device of a communication destination terminal (i.e., the number of vertical and horizontal display dots of an output screen) prior to the communication. Accordingly, for example if the number of vertical and horizontal dots of the screen of the display device in the communication destination terminal differs from that of the transmitting terminal, it becomes possible to reduce the transmission of unnecessary data and thus to realize smooth communication, by transmitting image data in reduced-size form or partly extracted form.

Processing in the above-described embodiment of the present invention can be constructed as a processing program, and this processing program can be supplied in the form where it is stored in/on a recording medium such as HD, DAT, FD, MO, DVD-ROM, or CD-ROM. The processing program can also be supplied via a communication medium such as the Internet or any other appropriate communication network.

The present invention has been described in terms of specific embodiments. These specific embodiments may be amended, modified, or altered without departing from the scope of the present invention. Accordingly, the scope of the present invention should be interpreted using the appended claims.

1. A communication terminal, comprising:
a display device configured to display an image on the display device according to image display parameters;
a processor to process the image data; and
a communication interface to transmit or receive data, the communication interface configured to be coupled to a remote image processing device via a network,
wherein the communication terminal transmits the display parameters to the remote image processing device to commence an image data communication operation between the communication terminal and the remote image processing device,
wherein the communication terminal receives first image data of a first image from the remote image processing device after the display parameters has been transmitted to the remote image processing device, the first image being a modified version of a first original image, and
wherein the first image is modified according to the display parameters provided to the remote image processing device by the communication terminal.

2. The communication terminal of claim 1, wherein the first image is a first portion of the first original image, the first original image including a second portion, wherein image data of the second portion of the first original image are not received by the communication terminal.

3. The communication terminal of claim 1, wherein the first image is a reduced image size of the first original image.

4. The communication terminal of claim 1, wherein the display parameters includes a display area dimension of the display device.

5. The communication terminal of claim 4, wherein the display parameters includes image resolution information of the display device.

6. The communication terminal of claim 1, wherein the first image has an image resolution that is less than an image resolution of the first original image.

7. The communication terminal of claim 6, wherein the display parameters includes image resolution information of the display device and the image resolution of the first image corresponds to the display parameters of the display device provided to the remote image processing device by the communication terminal.

8. The communication terminal of claim 1, wherein the first image is a first portion of the first original image, the first original image including a second portion, wherein image data of the second portion of the first original image are not received by the handheld communication terminal, the first portion of the first original image being a portion of the first original image selected by a user of the remote image processing device.

9. The communication terminal of claim 8, wherein the selection of the first portion is made on a display area of the remote image processing device.

10. The communication terminal of claim 1, wherein the communication terminal receives audio data corresponding to the first image data.

11. The communication terminal of claim 1, wherein the communication receives second image data corresponding to a second image from the remote image processing device, the second image being a modified version of a second original image, wherein the first and second original images are modified at the remote image processing device to generate the first and second image data.

12. The communication terminal of claim 1, wherein the first image has the same resolution as the first and second original images, and the second image has a lower resolution than the first or second original image.

13. The communication terminal of claim 1, wherein the communication terminal is a handheld device including a mobile telephone and a personal digital assistant.

14. A communication terminal, comprising:
a display device configured to display an image on the display device according to image first display parameters;
a processor to process the image data; and
a communication interface to transmit or receive data, the communication interface configured to be coupled to a remote handheld communication terminal via a network,
wherein the communication terminal receives second display parameters from the handheld communication terminal, the second display information providing information on resolution and size of an image that the handheld communication terminal is configured to display on a display area of the handheld communication terminal,
wherein the communication terminal generates a first image from an original image according to the second display parameters received from the handheld communication terminal, the first image being represented by first images data, and
wherein the first image data are transmitted to the handheld communication terminal.

15. A method for operating a communication terminal having a display device and a processor, the method comprising:
transmitting display parameters of the display device to the remote image processing device to commence an image data communication operation between the communication terminal and the remote image processing device; and
receiving at the communication terminal first image data of a first image from the remote image processing device after the display parameters has been transmitted to the remote image processing device, the first image being a modified version of a first original image,
wherein the first image is modified according to the display parameters provided to the remote image processing device by the communication terminal.

16. The method of claim 15, wherein the communication terminal is a handheld device being configured to be operated while being held on a user's hand.

17. The method of claim 15, wherein the first image is a reduced image size of the first original image.

18. The method of claim 15, wherein the display parameters includes a display area dimension of the display device.

19. The method of claim 15, wherein the display parameters includes image resolution information of the display device.

20. The method of claim 15, wherein the first image has an image resolution that is less than an image resolution of the first original image.
